(19) United States
(12) Patent Application Publication
(10) Pub. No.: US 2026/0179976 A1
(43) Pub. Date: Jun. 25, 2026

(54) SOLID OXIDE CELL STACK FASTENING APPARATUS AND SOLID OXIDE REACTION APPARATUS USING THE SAME

(71) Applicant: SAMSUNG ELECTRO-MECHANICS CO., LTD., Suwon-si, Gyeonggi-do (KR)

(72) Inventors: Dongsoon Woo, Suwon-si, Gyeonggi-do (KR); Dongjin Kim, Suwon-si, Gyeonggi-do (KR); Jeongsuong Yang, Suwon-si, Gyeonggi-do (KR); Jaehyuk Jang, Suwon-si, Gyeonggi-do (KR); Sung-Han Kim, Suwon-si, Gyeonggi-do (KR); Daehun Jeong, Suwon-si, Gyeonggi-do (KR); Sanghak Yoon, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/845,988

(22) PCT Filed: Aug. 12, 2024
(86) PCT No.: PCT/KR2024/011972

§ 371 Date: Sep. 11, 2024

(30) Foreign Application Priority Data
Oct. 31, 2023 (KR) 10-2023-0147412

(51) Int. Cl. H01M 8/0271; H01M 8/04082; H01M 8/04746; H01M 8/1004; H01M 8/12; H01M 8/1213; H01M 8/1253; H01M 8/242; H01M 8/2425; H01M 8/243; H01M 8/2432; H01M 8/248

(52) U.S. Cl. CPC H01M 8/0271; H01M 8/04201; H01M 8/04753; H01M 8/1004; H01M 8/12; H01M 8/1213; H01M 8/1253; H01M 8/242; H01M 8/2425; H01M 8/243; H01M 8/2432; H01M 8/248

(57) ABSTRACT

A solid oxide cell stack fastening apparatus, in which downward pressure applied to the solid oxide cell stack is uniform throughout, includes a housing which accommodates a solid oxide cell stack and includes a first coupling part on one side thereof, and a first block which includes a second coupling part and an elastic member in contact with the solid oxide cell stack. The first coupling part and the second coupling part each have screw threads coupled to each other.

### TECHNICAL FIELD

The present disclosure relates to a solid oxide cell stack fastening apparatus and a solid oxide reaction apparatus using the same.

### BACKGROUND ART

A solid oxide cell (SOC) is, for example, a solid oxide fuel cell (SOFC) or a solid oxide electrolyzer cell (SOEC), and produces electrical energy through an electrochemical reaction through a cell including an anode, a cathode, and a solid oxide electrolyte with oxygen ion conductivity or produces hydrogen by electrolyzing water in a reverse reaction of the solid oxide fuel cell.

The solid oxide cell has a configuration in which the anode and cathode are each disposed on both sides of the solid oxide electrolyte with the oxygen ion conductivity, and may produce electricity or perform electrolysis by supplying air and fuel to the anode and cathode respectively through a flow path formed in a separator to generate the electrochemical reaction.

The anode and cathode are locations where the actual reaction occurs, and generally has a porous structure because gases should be able to pass in and out easily for an effective reaction. On the other hand, the solid oxide electrolyte generally has a dense structure because a space should be separated to prevent air and fuel from passing. When unit cells of such a solid oxide cell are stacked to form a stack, edges and corners may be worn or damaged due to impact, etc., and damage may occur due to pressure imbalance even when pressure varies.

### DISCLOSURE OF INVENTION

### Technical Problem

The present disclosure attempts to provide a solid oxide cell stack fastening apparatus in which downward pressure applied to the solid oxide cell stack is uniform throughout.

However, problems to be solved by the embodiments are not limited to the above-described problems and may be variously extended in the range of technical ideas included in the embodiments.

### Solution to Problem

According to an embodiment, a solid oxide cell stack fastening apparatus includes a housing that accommodates a solid oxide cell stack and includes a first coupling part on one side of the housing, and a first block which includes a second coupling part and an elastic member in contact with the solid oxide cell stack. The first coupling part and the second coupling part each have screw threads coupled to each other.

The elastic member may be disposed in plural.

The first block may further include a first cover disposed on the second coupling part.

The first block may further include a protrusion that extends from the first cover toward the housing and protrudes further than the second coupling part. The elastic member may be disposed in the protrusion.

The protrusion may have a hole in which the elastic member is accommodated.

The first cover may have a cross-shaped hole on an upper surface of the first cover.

The housing may include a frame that extends from the first coupling part and has an upper open hole opened in a direction toward the first block and a lower open hole opened in a direction opposite to the upper open hole, and the frame may have a through hole that is opened in a direction different from the directions in which the upper and lower open holes are opened.

The solid cell stack fastening apparatus may further include a stack guide disposed inside the housing and in contact with the solid oxide cell stack.

The solid oxide cell stack may have a square pillar shape, the stack guide may be disposed in four, and each of the four stack guides may be in contact with four edges which connect upper and lower surfaces of the solid oxide cell stack.

The solid cell stack fastening apparatus may further include a second block that is connected to the other side of the housing.

The second block may include: a second cover which covers the other side of the housing; a stack seating part disposed on an upper surface of the second cover; and a guide seating part disposed around the stack seating part.

According to another embodiment, a solid oxide reaction apparatus includes a housing which includes a frame and a first coupling part on one side of the frame, a solid oxide cell stack accommodated in an internal space formed by the frame, and a first block which includes a second coupling part fastened to the first coupling part by rotation. The first block includes an elastic member in contact with an upper surface of the solid oxide cell stack.

The first block may further include a protrusion in contact with the upper surface of the solid oxide cell stack, and the elastic member may be disposed on the protrusion.

The solid oxide cell stack may have a square pillar shape, and the elastic member may be disposed in four.

According to still another embodiment, a solid oxide reaction apparatus may include a housing, a solid oxide cell stack accommodated in an internal space of the housing, and a first block including at least one elastic member, in which the at least one elastic member may be configured to apply downward pressure to an upper surface of the solid oxide cell stack as the first block is fastened to the housing in a rotating manner.

The housing and the first block each may have screw threads to be fastened to each other.

The first block may further include a first cover and a side wall extending from an outer edge of the first cover and having the screw threads, in which the first block further includes a protrusion that extends from the first cover toward the housing and protrudes further than an end of the side wall, and the protrusion is spaced apart from the screw threads of the first block.

The at least one elastic member may be disposed in a lower surface of the protrusion, and when the first block is coupled to the housing, the protrusion may descend while maintaining a parallelism between the lower surface of the protrusion and the upper surface of the solid oxide cell stack.

The solid oxide reaction apparatus may further include at least one stack guide disposed in the housing and extending along a side surface of the solid oxide cell stack to limit a position of the solid oxide cell stack inside the housing and apply physical force by contacting edges of the solid oxide cell stack, and a second block coupled to the housing at an opposite side of the first block, The second block may include a second cover which covers a lower side of the housing and includes a recessed portion having a depth on an upper surface of the second cover to accommodate a lower portion of the solid oxide cell stack and an end portion of the at least one stack guide. The recessed portion may have a shape corresponding to an outer shape of the solid oxide cell stack and the at least one stack guide. The recessed portion may have an area of 10% to 30% larger than an area of a lower surface of the solid oxide cell stack.

### Advantageous Effects of Invention

According to the solid oxide cell stack fastening apparatus of the embodiment, by combining the housing and the first block in the rotating manner and by applying the pressure, which does not differ in each part, to the upper portion of the solid oxide cell stack, it is possible to prevent damage to the solid oxide cell stack due to the pressure difference for each part.

However, it is obvious that the effects of the embodiments are not limited to the above-described effects, and may be variously extended without departing from the spirit and scope of the present disclosure.

### BRIEF DESCRIPTION OF DRAWINGS

FIG. 1 is a perspective view of a solid oxide cell stack fastening apparatus according to an embodiment of the present disclosure.

FIG. 2 is an exploded perspective view of the solid oxide cell stack fastening apparatus illustrated in FIG. 1.

FIG. 3 is an exploded bottom perspective view of the solid oxide cell stack fastening apparatus illustrated in FIG. 1.

FIG. 4 is a diagram separately illustrating a first block illustrated in FIG. 1.

FIG. 5 is a diagram illustrating a second block illustrated in FIG. 1 separated.

FIG. 6 is a diagram illustrating a solid oxide cell stack and a stack guide accommodated in a housing illustrated in FIG. 1.

FIG. 7 is a diagram illustrating a unit cell 410 constituting a solid oxide cell stack 400 illustrated in FIG. 6.

FIG. 8 is a schematic diagram illustrating a case where the unit cell 410 is a solid oxide fuel cell 500.

FIG. 9 is a schematic diagram describing a case where the unit cell 410 is a solid oxide electrolyzer cell 600.

### MODE FOR THE INVENTION

Hereinafter, embodiments of the present disclosure will be described in detail with reference to the accompanying drawings so that those skilled in the art to which the present disclosure pertains may easily practice the present disclosure. The drawings and description are to be regarded as illustrative in nature and not restrictive. Like reference numerals designate like elements throughout the specification. In addition, it is to be noted that some components shown in the drawings are exaggerated, omitted or schematically illustrated, and the size of each component does not exactly reflect its real size.

It should be understood that the accompanying drawings are provided only in order to allow embodiments of the present disclosure to be easily understood, and the spirit of the present disclosure is not limited by the accompanying drawings, but includes all the modifications, equivalents, and substitutions included in the spirit and the scope of the present disclosure.

Terms including an ordinal number such as first, second, etc., may be used to describe various components, but the components are not limited to these terms. The terms are used only to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, when an element is referred to as being “on” a reference element, it can be positioned on or beneath the reference element, and is not necessarily positioned on the reference element in an opposite direction to gravity.

It will be further understood that the terms “include” or “have” used in the present specification, specify the presence of features, numerals, steps, operations, components, parts mentioned in the present specification, or a combination thereof, but do not preclude the presence or addition of one or more other features, numerals, steps, operations, components, parts, or a combination thereof. Accordingly, unless explicitly described to the contrary, “comprising” any components will be understood to imply the inclusion of other components rather than the exclusion of other components.

Further, throughout the specification, the word “plan view” refers to a view when a target is viewed from the top, and the word “cross-sectional view” refers to a view when a cross section of a target taken along a vertical direction is viewed from the side.

Also, throughout the specification, when it is said to be “connected”, this does not mean that two or more components are directly connected, but means that two or more components are indirectly connected through another component, that two or more components are physically connected as well as electrically connected, or that two or more components are referred to by different names depending on their location or function, but are integral.

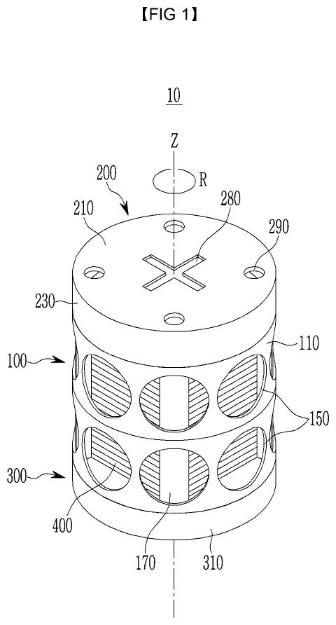

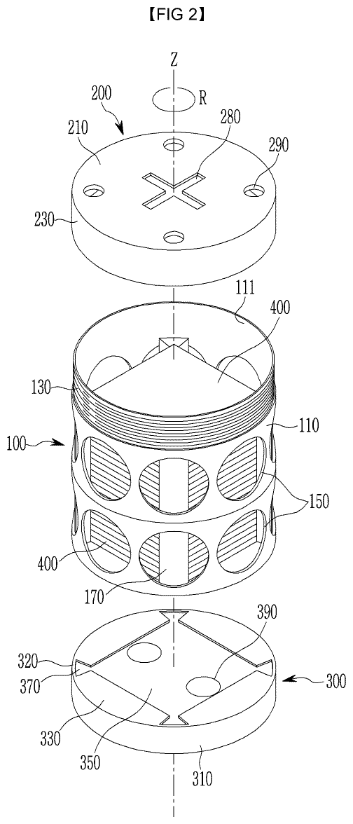

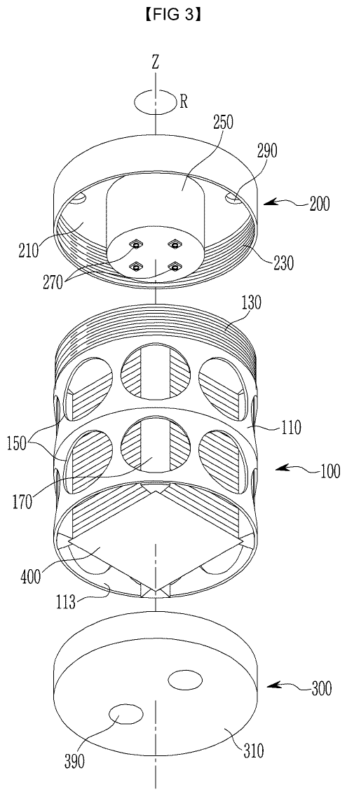

FIG. 1 is a schematic perspective view of a solid oxide cell stack fastening apparatus according to an embodiment of the present disclosure, FIG. 2 is an exploded perspective view of the solid oxide cell stack fastening apparatus illustrated in FIG. 1, and FIG. 3 is an exploded bottom perspective view of the solid oxide cell stack fastening apparatus illustrated in FIG. 1.

Referring to FIGS. 1 to 3, a solid oxide cell stack fastening apparatus 10 according to the embodiment may include a housing 100, a first block 200 coupled to the housing 100, and a second block 300 that is coupled to the housing 100 and is opposite to the first block 200.

The housing 100 may include a frame 110 that has upper and lower portions opened and has a space formed therein. That is, the frame 110 may have an upper open hole 111 opened in a direction toward the first block 200 and a lower open hole 113 opened in an opposite direction thereto, that is, in a direction toward the second block 300, and have a hollow formed therein so that a solid oxide cell stack 400 may be accommodated. FIGS. 1 to 3 illustrate that the housing 100 has a cylindrical shape with a circular cross-section, but the present disclosure is not limited thereto. The housing 100 may have various shapes such as a hexagonal cylindrical shape having a hexagonal cross-section or a quadrangular cylindrical shape with a square cross-section. The solid oxide cell stack 400 may be accommodated in a hollow inside the housing 100. The solid oxide cell stack 400 may be disposed in a middle portion of the housing 100 in a plane direction (R direction in the drawing, radial direction of a Z-axis).

A stack guide 170 may be disposed in the housing 100. The stack guide 170 may limit a position of the solid oxide cell stack 400 inside the housing 100. The stack guide 170 may apply physical force by contacting edges of the solid oxide cell stack 400, which has an approximately hexahedral shape, and may maintain the position of the solid oxide cell stack 400 within a certain range. In addition, the stack guide 170 may be coupled to the second block 300 to limit the movement of the solid oxide cell stack 400 within a certain range even when the solid oxide cell stack 400 vibrates, expands, or contracts.

The first coupling part 130 may be formed to extend from the frame 110. The first coupling part 130 may have the same cylindrical shape as the frame 110 and may be manufactured together with the frame 110. The first coupling part 130 may be disposed on an upper portion of the housing 100, that is, above the frame 110, and may be coupled to the first block 200. A coupling member coupled to the first block 200 may be formed in the first coupling part 130. As an example, the coupling member may be formed of a screw thread. The screw thread may be formed on an outer surface of the first coupling part 130.

A through hole 150 may be formed in the frame 110 of the housing 100. That is, the through hole 150 may be opened in a direction (e.g., a radial direction) different from the direction in which the upper open hole 111 is opened and the direction in which the lower open hole 113 is opened. The through hole 150 may connect the internal space of the housing 100 to the outside, and heat generated in the solid oxide cell stack 400 may be smoothly discharged to the outside through the through hole 150. FIGS. 1 to 3 illustrate that the through hole 150 formed in the frame 110 of the housing 100 has a circular shape, but the present disclosure is not limited thereto and may be formed in various shapes such as polygons. The through hole 150 may be one or a plurality of through holes 150.

FIG. 4 is a diagram illustrating a first block illustrated in FIG. 1 separated.

Referring to FIGS. 1, 2, 3, and 4, the first block 200 may be positioned at the upper portion of the housing 100. The first block 200 may be an upper block disposed above the housing 100. The first block 200 may be manufactured separately and coupled to the first coupling part 130 disposed on the frame 110 of the housing 100. The first block 200 may apply downward pressure to the solid oxide cell stack 400 disposed in the housing 100. The housing 100 may include a first cover 210, a second coupling part 230, a protrusion 250, and an elastic member 270.

The first cover 210 may serve as a cover that covers the housing 100 when the first block 200 is coupled to the housing 100. The first cover 210 may be an upper cover that covers the housing 100. As an example, the first cover 210 may have a disk shape whose outer surface is the same as or larger than an outer surface of the housing 100. However, the present disclosure is not limited thereto, and the first cover 210 may have other shapes such as a triangular plate or a quadrangular plate. In addition, the first cover 210 has an approximately disk shape, and a curvature may be formed on an outer peripheral surface of the upper portion.

A first flow path 290 may be formed in the first cover 210. The first flow path 290 may be a hole penetrating through the first cover 210. A first supply member may be connected to the solid oxide cell stack 400 from the outside through the first flow path 290. As an example, the first supply member may be connected to a cathode positioned in each unit cell of the solid oxide cell stack 400. FIG. 3 illustrates that four first flow paths 290 are formed in the first cover 210, but is not limited thereto.

The second coupling part 230 may extend downward from the outer peripheral portion of the first cover 210 and be coupled to the first coupling part 130 of the housing 100. That is, the second coupling part 230 may have an annular shape. The second coupling part 230 may be molded integrally with the first cover 210.

A coupling member fastened to the first coupling part 130 may be formed in the second coupling part 230. As an example, the coupling member of the second coupling part 230 may be formed of a screw thread. The screw thread of the second coupling part 230 may be formed on an inner surface of the second coupling part 230.

The protrusion 250 may extend downward from a lower surface of the first cover 210. The protrusion 250 may be formed to be spaced apart from the second coupling part 230. The protrusion 250 may be connected to approximately a center portion of the first cover 210. For example, the protrusion 250 may have a cylindrical shape, and a center of the lower surface of the first cover 210 may be a center of an upper surface of the cylinder. The protrusion 250 may be molded integrally with the first cover 210, or may be molded separately and then coupled to the first cover 210 in a later process.

The protrusion 250 may contact the solid oxide cell stack 400 inside the housing 100 when the first block 200 is coupled to the housing 100. An elastic member receiving part 253 may be formed in the protrusion 250. The elastic member receiving part 253 may be one or more holes formed from a lower surface of the protrusion 250. A panel 255 may be formed around the hole formed by the elastic member receiving part 253. In FIG. 4, the panel 255 has the shape of a quadrangular plate, but is not limited thereto.

The elastic member 270 may be accommodated in the elastic member receiving part 253 of the protrusion 250. An upper portion of the elastic member 270 may be received in the hole-shaped elastic member receiving part 253 of the protrusion 250, and a lower portion may protrude from the hole. As an example, the elastic member 270 may be a spring. FIGS. 3 and 4 illustrate that four holes are formed in the protrusion 250 as the elastic member receiving part 253 and four elastic members 270 are positioned in each hole, but the present disclosure is not limited thereto. One or a plurality of holes may be formed as the elastic member receiving part 253. As an example, the elastic member 270 may be positioned above a vertex of the solid oxide cell stack 400 with respect to an upper surface of the solid oxide cell stack 400.

When the first block 200 is coupled to the housing 100, the elastic member 270 is contracted by upward pressure applied from the solid oxide cell stack 400 while the lower surface of the protrusion 250 contacts the upper surface of the solid oxide cell stack 400, so the elastic member 270 may be completely accommodated in the hole of the protrusion 250.

When the solid oxide cell stack 400 is spaced apart from the protrusion 250 due to the contraction or the like during the electrolysis process, the elastic member 270 may partially protrude from the hole of the protrusion 250 due to restoring force. When the elastic member 270 partially protrudes as described above, the elastic member 270 may contact the upper portion of the solid oxide cell stack 400 and apply downward pressure to the solid oxide cell stack 400. As an example, four elastic members 270 may be disposed. The four elastic members 270 may be disposed so that a distance from the central axis (Z-axis in the drawing) is the same, and a distance between each elastic member 270 is also the same. The four elastic members 270 may be positioned above edges of the solid oxide cell stack 400, respectively.

The lower surface of the protrusion 250 may be parallel to the upper surface of the solid oxide cell stack 400. When the first coupling part 130 and the second coupling part 230 are rotationally coupled, the lower surface of the protrusion 250 and the upper surface of the solid oxide cell stack 400 come into contact by approaching each other in a parallel state, so the downward pressure applied by the protrusion 250 at a portion where the protrusion 250 and the solid oxide cell stack 400 come into contact may be the same.

When the plurality of elastic members 270 are disposed, modulus of elasticity of the elastic members 270 may be the same. Since the plurality of elastic members 270 have the same modulus of elasticity, when the solid oxide cell stack 400 contracts, the downward pressure applied to the portion where the elastic member contacts the solid oxide cell stack 400 may be the same. Since the plurality of elastic members 270 have the same distance from each other with respect to the central axis (Z-axis in the drawing) and the distance between the plurality of elastic members 270 is also the same, the pressure applied to the solid oxide cell stack 400 from the plurality of elastic members 270 may be uniform.

A coupling auxiliary part 280 may be formed on an upper surface of the first cover 210. The coupling auxiliary part 280 may serve to facilitate the fastening of the first block 200 and the housing 100. For example, the coupling auxiliary part 280 may be a cross-shaped groove or a straight groove formed on the upper surface of the first cover 210. When a separate device is inserted into the cross-shaped groove or straight groove formed by the coupling auxiliary part 280 and applies a torque, the first block 200 rotates and a screw thread formed in the second coupling part 230 rotates together, so the screw threads formed in the coupling part 230 may be mutually coupled with a screw thread formed in the first coupling part 130.

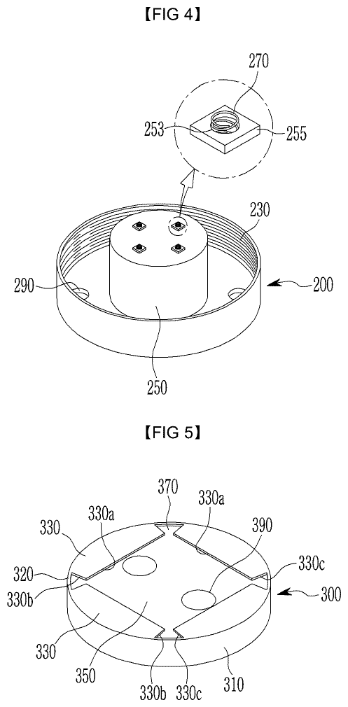

FIG. 5 is a diagram illustrating the second block illustrated in FIG. 1 separated.

Referring to FIGS. 1, 2, 3, and 5, the second block 300 may be a lower block positioned below the housing 100. The housing 100 may be seated on the second block 300. The second block 300 may include a second cover 310, an edge portion 320, an extension 330, a stack seating part 350, and a guide seating part 370.

The second cover 310 may be a lower cover that covers a lower portion of the opened and closed housing 100. As an example, the second cover 310 may have a disk shape whose outer surface is the same as or larger than the outer surface of the housing 100. However, the present disclosure is not limited thereto, and the second cover 310 may have various shapes such as a triangular plate or a quadrangular plate.

The edge portion 320 may be formed on an upper surface of the second cover 310. The edge portion 320 may have a shape that protrudes upward (in the Z-axis direction in the drawing) along an edge of the second cover 310. The edge portion 320 may serve to prevent the stack guide 170 from being separated from the second block 300.

The extension 330 may be formed on the upper surface of the second cover 310. The extension 330 may protrude from the edge portion 320 toward a central axis of the second cover 310, and protrude upward (in the Z-axis direction in the drawing) with respect to the upper surface of the second cover 310. A protruding height of the extension 330 may be the same as that of the edge portion 320 with respect to the upper surface of the second cover 310, but the present disclosure is not limited thereto. An upper surface of the extension 330 may be parallel to the upper surface of the second cover 310.

A plurality of extensions 330 may be formed. Each extension 330 has a first side surface 330a opposite to the central axis (Z-axis in the drawing) of the second cover 310, and second and third side surfaces 330b and 330c connecting the first side surface 330a and the edge portion 320. Each first side surface 330a may be a plane perpendicular to the upper surface of the second cover 310.

As an example, four extensions 330 may be formed. The four extensions 330 may be composed of two pairs of extensions 330 facing each other, and the first side surfaces 330a of the extensions 330 adjacent to each other may be perpendicular to each other. That is, the first side surfaces 330a of the four extensions 330 may form a quadrangular shape with opened edges.

The stack seating part 350 may be formed on the upper surface of the second cover 310. The stack seating part 350 may be formed in a middle portion of the upper surface of the second cover 310. At least a portion of an edge of the stack seating part 350 may be formed by the first side surface 330a of the extension 330. That is, the first side surface 330a of the extension 330 may be a boundary surface of the stack seating part 350.

The solid oxide cell stack 400 is seated on the stack seating part 350, and the first side surface 330a of the extension 330 may guide the position of the solid oxide cell stack 400. An area of the stack seating part 350 may be larger than that of a lower surface of the solid oxide cell stack 400. For example, the area of the stack seating part 350 may be 10% to 30% larger than an area of the lower surface of the solid oxide cell stack 400. When the area of the stack seating part 350 is larger than that of the lower surface of the solid oxide cell stack 400, a margin may be secured when the solid oxide cell stack 400 expands during a hydrogen generation process.

The guide seating part 370 may be formed between the second side surface 330b and the third side surface 330c of the adjacent extensions 330. That is, the guide seating part 370 may be formed by the second side surface 330b of one extension 330, and the third side surface 330c and the edge portion 320 of the adjacent extension 330, and may be connected to the stack seating part 350. The stack guide 170 may be seated on the guide seating part 370. The second side surface 330b and third side surface 330c of the extension 330, and the edge part 320 may guide a position of the stack guide 170. That is, the second side surface 330b and third side surface 330c of the extension 330, and the edge portion 320 may limit a movement range of the stack guide 170 seated on the guide seating part 370. The guide seating part 370 may be formed 10% to 30% larger than an area of a lower portion of the stack guide 170 to secure a movement margin of the stack guide 170 that moves as the solid oxide cell stack 400 expands.

A second flow path 390 may be formed in the second cover 310. The second flow path 390 may be a hole penetrating through the second cover 310. A second supply member may be connected to the solid oxide cell stack 400 from the outside through the second flow path 390. As an example, the second supply member may be connected to an anode positioned in each cell of the solid oxide cell stack 400. FIGS. 2, 3, and 5 illustrate that two second flow paths 390 are formed in the second cover 310, but the present disclosure is not limited thereto.

It is illustrated that the first supply member is connected to anodes positioned in each unit cell of the solid oxide cell stack 400 through the first flow path 290, and the second supply member is connected to cathodes located in each unit cell of the solid oxide cell stack 400 through the second flow path 390, but the present disclosure is not limited thereto. As another example, the first supply member may be connected to the cathodes positioned in each unit cell of the cell stack 400, and the second supply member may be connected to the anodes positioned in each unit cell of the cell stack 400.

FIG. 6 is a diagram illustrating the solid oxide cell stack coupled to the stack guide illustrated in FIGS. 1 to 3.

Referring to FIG. 6, a height (length measured in the Z-axis direction in the drawing) of the stack guide 170 may be the same as that of the solid oxide cell stack 400, but is not limited thereto. The position of the stack guide 170 may be maintained or fixed within a certain range by the second block 300. The stack guides 170 may be arranged at regular intervals based on the center of the stack guides 170, and thus, the solid oxide cell stack 400 may be disposed between the stack guides 170.

A plurality of stack guides 170 may be disposed at a distance from each other. For example, the solid oxide cell stack 400 may have a square pillar shape, and four edges connecting the upper and lower surfaces of the solid oxide cell stack 400 may be formed. Four stack guides 170 may be disposed, and each of the four stack guides 170 may contact four edges which connect the upper and lower surfaces of the solid oxide cell stack 400.

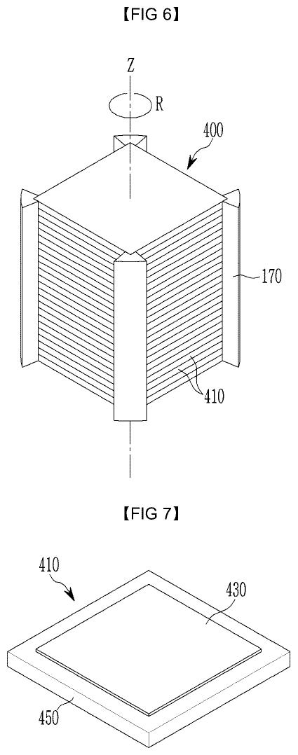

The stack guide 170 has an approximately fan-shaped cross-section, and a V-shaped trench may be formed at a central angle. An angle formed by two sides of the V-shaped trench may be approximately 90°. Four edges connecting the upper and lower surfaces of the solid oxide cell stack 400 may be accommodated in the trench of the stack guide 170, and thus, the position in a planar direction (R direction in the drawing, radial direction of the Z-axis) of the solid oxide cell stack 400 may be limited. In addition, the damage to the stack may be minimized by protecting the edges of the solid oxide cell stack 400. FIG. 7 is a diagram illustrating a unit cell 410 constituting the solid oxide cell stack 400 illustrated in FIG. 6.

Referring to FIG. 7, the unit cell 410 constituting the solid oxide cell stack 400 includes a solid oxide electrolyte 450, a cathode (not illustrated) disposed on one side of the solid oxide electrolyte 450, and an anode 430 (not illustrated) on the other side.

The anode 430 includes an anode material. The anode material may be a material that reduces oxygen gas to oxygen ions.

For example, the anode material may be metal oxide particles having a perovskite-type crystal structure. A perovskite-type metal oxide is a mixed conductor (mixed ionic-electronic conductor (MIEC)) material that has both ionic conductivity and electronic conductivity, and has a high oxygen diffusion coefficient and charge exchange reaction rate coefficient, and thus, may allow a reduction reaction of oxygen to occur not only at a triple phase boundary but also on the entire surface of the electrode.

The perovskite-type metal oxide may be represented by the following Chemical Formula 1.

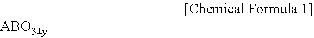

In Chemical Formula 1, A is an element including La, Ba, Sr, Sm, Gd, Ca, or a combination thereof, B is an element including Mn, Fe, Co, Ni, Cu, Ti, Nb, Cr, Sc, or a combination thereof, and y represents oxygen excess or oxygen deficiency. y may have the range, for example, 0≤y≤0.3.

For example, the perovskite-type metal oxide may be represented by the following Chemical Formula 2.

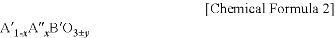

In Chemical Formula 2, A′ is an element including Ba, La, Sm, or a combination thereof, A″ is an element including Sr, Ca, Ba, or a combination thereof, and is different from A′, B′ is an element including Mn, Fe, Co, Ni, Cu, Ti, Nb, Cr, Sc, or a combination thereof, and 0≤x<1, and y represents excess oxygen or oxygen deficiency.

As an example, the anode material may include lanthanum-strontium manganese oxide (LSM), lanthanum-strontium iron oxide (LSF), lanthanum-strontium cobalt oxide (SSC), lanthanum-strontium cobalt iron oxide (LSCF), samarium-strontium cobalt oxide (SSC), barium-strontium cobalt iron oxide (BSCF), bismuth-ruthenium oxide, or a combination thereof.

The anode 430 may further include a solid oxide electrolyte material.

As an example, the solid oxide electrolyte material may include yttria-stabilized zirconia (YSZ), scandia-stabilized zirconia (ScSZ), gadolinia-doped ceria (GDC), samaria-doped ceria (SDC), strontium- and magnesium-doped lanthanum gallate (LSGM), samaria and ceria-doped barium zirconate (BaZrO₃), samaria and ceria-doped barium cerate (BaCeO₃), bismuth oxide (Bi₂O₃), or combinations thereof.

In this case, when the solid oxide electrolyte material is yttria-stabilized zirconia (YSZ) and the anode material is lanthanum-strontium manganese oxide (LSM), the porous solid oxide composite may be an LSM-YSZ composite.

A thickness of the anode 430 may be, for example, 1 μm to 100 μm or 5 μm to 50 μm.

The cathode plays a role in electrochemical oxidation of the fuel and charge transfer.

As an example, the cathode material may include pure metals such as nickel (Ni), cobalt (Co), ruthenium (Ru), palladium (Pd), or platinum (Pt), or oxides thereof.

The cathode may further include the solid oxide electrolyte material.

As an example, the solid oxide electrolyte material may include yttria-stabilized zirconia (YSZ), scandia-stabilized zirconia (ScSZ), gadolinia-doped ceria (GDC), samaria-doped ceria (SDC), strontium- and magnesium-doped lanthanum gallate (LSGM), samaria and ceria-doped barium zirconate (BaZrO₃), samaria and ceria doped barium cerate (BaCeO₃), bismuth oxide (Bi₂O₃), or combinations thereof.

In this case, the cathode may include a cermet in which the cathode material and the solid oxide electrolyte material are combined. For example, when the solid oxide electrolyte material is yttria-stabilized zirconia (YSZ) and the cathode material is nickel (Ni), a porous solid oxide composite may be Ni/YSZ cermet, and when the cathode material is ruthenium (Ru), the porous solid oxide composite may be Ru/YSZ cermet.

For example, a thickness of the cathode may be 1 μm to 1000 μm or 5 μm to 100 μm.

The solid oxide electrolyte 450 serves to transport oxygen ions generated at the anode 430 to the cathode through the ion conduction.

The solid oxide electrolyte 450 should have gas impermeability to block contact between air and the cathode, and has high oxygen ion conductivity and low electronic conductivity (high electrical resistance, high insulation), so it should be possible to block electrons generated at the fuel electrode from moving directly to the air electrode 430.

In addition, since the solid oxide electrolyte 450 has the anode 430 and the cathode with a very large oxygen partial pressure difference on both sides, it is necessary to maintain the above physical properties in a wide oxygen partial pressure region.

The materials constituting the solid oxide electrolyte 450 are not particularly limited as long as they are generally available in the relevant technical field, and examples of the materials may include yttria-stabilized zirconia (YSZ), scandia-stabilized zirconia (ScSZ), gadolinia-doped ceria (GDC), samaria-doped ceria (SDC), strontium- and magnesium-doped lanthanum gallate (LSGM), samaria and ceria doped barium zirconate (BaZrO₃), samaria and ceria doped barium cerate (BaCeO₃), bismuth oxide (Bi₂O₃), or combinations thereof.

Optionally, the unit cell 410 may further include an electric current collection layer (not illustrated) including an electronic conductor on at least one side of the anode 430, for example, on an outer side of the anode 430. The electric current collection layer may serve as a current collector to collect electricity in the configuration of the anode 430.

The electric current collection layer may include, for example, lanthanum cobalt oxide (LaCoO₃), lanthanum strontium cobalt oxide (LSC), lanthanum strontium cobalt iron oxide (LSCF), lanthanum strontium cobalt manganese oxide (LSCM), lanthanum strontium manganese oxide (LSM), lanthanum strontium iron oxide (LSF), or a combination thereof. The electric current collection layer may be used alone or in a mixture of two or more of the materials listed above, and may be formed of a single layer using these materials, or a plurality of two or more stacked structures.

As an example, the unit cell 410 may be a solid oxide fuel cell (SOFC), a solid oxide electrolyzer cell (SOEC), or both.

FIG. 8 is a schematic diagram illustrating a case where the unit cell 410 is a solid oxide fuel cell 500.

Referring to FIG. 8, the solid oxide fuel cell 500 includes a cathode 510, an anode 520 disposed facing the cathode 510, and an oxygen ion solid oxide electrolyte 530 disposed between the cathode 510 and the anode 520.

As illustrated in Scheme 1 below, an electrochemical reaction of the solid oxide fuel cell 500 includes an anode reaction in which oxygen gas O₂ of the air electrode 520 changes into oxygen ion O₂_{^{−}} and a cathode reaction in which oxygen ions moving through fuel (H₂ or hydrocarbon) and electrolyte of the cathode 510 react.

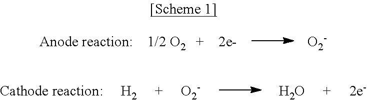

In the anode 520 of the solid oxide fuel cell 500, oxygen adsorbed on an electrode surface undergoes dissociation and surface diffusion to move to a triple phase boundary where the solid oxide electrolyte 530, the air electrode 520, and pores (not illustrated) meet, so the oxygen gains electrons and becomes oxygen ions. The generated oxygen ions move to the cathode 510 through the solid oxide electrolyte 530.

In the cathode 510 of the solid oxide fuel cell 500, the moving oxygen ions are combined with hydrogen included in the fuel to generate water. In this case, hydrogen emits electrons to change into hydrogen ions (H+) and is combined with oxygen ions. The emitted electrons move to the anode 520 through wiring (not illustrated) and change oxygen into oxygen ions. Through this electron movement, the solid oxide fuel cell 500 may perform a battery function.

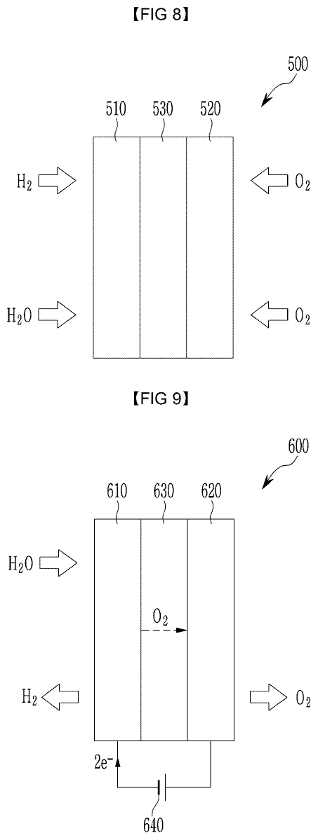

FIG. 9 is a schematic diagram describing a case where the unit cell 410 is a solid oxide electrolyzer cell 600.

Referring to FIG. 9, the solid oxide electrolyzer cell 600 includes an anode 610, a cathode 620 disposed facing the anode 610, and an oxygen ion conductive solid oxide electrolyte 630 disposed between the anode 610 and the cathode 620.

As illustrated in Scheme 2 below, an electrochemical reaction of the solid oxide electrolyzer cell 600 includes a cathode reaction in which water (H₂O) in the cathode 620 changes into hydrogen gas (H₂) and oxygen ions (O₂) and an anode reaction in which oxygen ions moving through the solid oxide electrolyte 630 change into oxygen gas (O₂). This reaction is opposite to a reaction principle of a typical fuel cell.

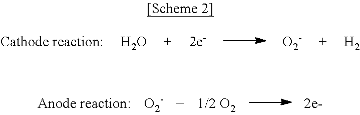

When power is applied to the solid oxide electrolyzer cell 600 from an external power source 640, electrons are provided from the external power source 640 to the solid oxide electrolyzer cell 600. Electrons react with water provided to the cathode 620 to generate hydrogen gas and oxygen ions. Hydrogen gas is discharged to the outside, and oxygen ions pass through the electrolyte 630 and move to the anode 610. Oxygen ions moving to the anode 610 lose electrons and are converted into oxygen gas and discharged to the outside. Electrons flow to the external power source 640. Through this electron movement, the solid oxide electrolyzer cell 600 may electrolyze water to form hydrogen gas at the cathode 620 and oxygen gas at the anode 610. In general, when the solid oxide cell stack 400 operates at a high temperature, a difference in degrees of contraction and expansion between the elements constituting the solid oxide cell stack 400 may occur due to a difference in thermal expansion coefficients constituting the solid oxide cell stack 400. This difference in contraction and expansion may cause the results in which the components of the solid oxide cell stack 400 including the unit cell 410 are separated, and the solid oxide cell stack fastening apparatus 10 may apply equal pressure to the solid oxide cell stack 400 to prevent such separation and allow the solid oxide cell stack 400 to operate normally. In addition, when the solid oxide cell stack 400 expands, the protrusion 250 may maintain pressure on the solid oxide cell stack 400, and when the solid oxide cell stack 400 contracts, the elastic member 270 may maintain the pressure on the solid oxide cell stack 400.

In addition, when the first block 200 is coupled to the housing 100, the protrusion 250 descends while maintaining the parallelism between the lower surface of the protrusion 250 and the upper surface of the solid oxide cell stack 400, so the downward pressure applied to the solid oxide cell stack 400 may be uniform. Accordingly, it is possible to prevent the damage to the solid oxide cell stack 400 that may occur due to pressure imbalance.

In addition, even when the solid oxide cell stack 400 contracts, the elastic members 270 accommodated in the elastic member receiving part 253 of the protrusion 250 may protrude and continue to apply pressure to the solid oxide cell stack 400. The elastic members 270 may have the same modulus of elasticity and apply pressure by contacting the edges of the upper surface of the solid oxide cell stack 400, so the downward pressure uniformity may be maintained.

Although preferred embodiments of the present disclosure have been described above, the present disclosure is not limited thereto, and the present disclosure can be variously modified within the scope of the claims, the description of the disclosure, and the appended drawings, and it is natural that various modifications also fall within the scope of the present disclosure.

### DESCRIPTION OF SYMBOLS

10: Solid oxide cell stack fastening apparatus
100: Housing
110: Frame
130: First coupling part
150: Through hole
170: Stack guide
200: First block
210: First cover
230: Second coupling part
250: Protrusion
270: Elastic member
290: First flow path
300: Second block
310: Second cover
320: Edge portion
330: Extension
350: Stack seating part
370: Guide seating part
390: Second flow path
400: Solid oxide cell stack
410: Unit cell
430: Anode
450: Solid oxide electrolyte

1. A solid cell stack fastening apparatus, comprising:
a housing which accommodates a solid oxide cell stack and comprises a first coupling part on one side of the housing; and
a first block which comprises a second coupling part and an elastic member in contact with the solid oxide cell stack,
wherein the first coupling part and the second coupling part each have screw threads coupled to each other.

2. The solid cell stack fastening apparatus of claim 1, wherein:
the elastic member is disposed in plural.

3. The solid cell stack fastening apparatus of claim 1, wherein:
the first block further comprises a first cover disposed on the second coupling part.

4. The solid cell stack fastening apparatus of claim 3, wherein:
the first block further comprises a protrusion that extends from the first cover toward the housing and protrudes further than the second coupling part.

5. The solid cell stack fastening apparatus of claim 4, wherein:
the elastic member is disposed in the protrusion.

6. The solid cell stack fastening apparatus of claim 5, wherein:
the protrusion has a hole in which the elastic member is accommodated.

7. The solid cell stack fastening apparatus of claim 3, wherein:
the first cover has a cross-shaped hole on an upper surface of the first cover.

8. The solid cell stack fastening apparatus of claim 1, wherein:
the housing comprises a frame that extends from the first coupling part and has an upper open hole opened in a direction toward the first block, and a lower open hole opened in a direction opposite to the upper open hole, and
the frame has a through hole that is opened in a direction different from the directions in which the upper and lower open holes are opened.

9. The solid cell stack fastening apparatus of claim 1, further comprising:
a stack guide disposed inside the housing and in contact with the solid oxide cell stack.

10. The solid cell stack fastening apparatus of claim 9, wherein:
the solid oxide cell stack has a square pillar shape,
the stack guide is disposed in four, and
each of the four stack guides is in contact with four edges which connect upper and lower surfaces of the solid oxide cell stack.

11. The solid cell stack fastening apparatus of claim 1, further comprising:
a second block connected to another side of the housing.

12. The solid cell stack fastening apparatus of claim 11, wherein:
the second block comprises
a second cover which covers the another side of the housing,
a stack seating part disposed on an upper surface of the second cover, and
a guide seating part disposed around the stack seating part.

13. A solid oxide reaction apparatus, comprising:
a housing which comprises a frame and a first coupling part on one side of the frame;
a solid oxide cell stack accommodated in an internal space formed by the frame; and
a first block which comprises a second coupling part fastened to the first coupling part by rotation,
wherein the first block comprises an elastic member in contact with an upper surface of the solid oxide cell stack.

14. The solid oxide reaction apparatus of claim 13, wherein:
the first block further comprises a protrusion in contact with the upper surface of the solid oxide cell stack, and
the elastic member is disposed in the protrusion.

15. The solid oxide reaction apparatus of claim 14, wherein:
the solid oxide cell stack has a square pillar shape, and
the elastic member is disposed in four.

16. A solid oxide reaction apparatus, comprising:
a housing;
a solid oxide cell stack accommodated in an internal space of the housing; and
a first block including at least one elastic member,
wherein the at least one elastic member is configured to apply downward pressure to an upper surface of the solid oxide cell stack as the first block is fastened to the housing in a rotating manner.

17. The solid oxide reaction apparatus of claim 16, wherein
the housing and the first block each have screw threads to be fastened to each other.

18. The solid oxide reaction apparatus of claim 16, wherein:
the first block further comprises a first cover and a side wall extending from an outer edge of the first cover and having the screw threads,
wherein the first block further comprises a protrusion that extends from the first cover toward the housing and protrudes further than an end of the side wall, and
the protrusion is spaced apart from the screw threads of the first block.

19. The solid oxide reaction apparatus of claim 18, wherein:
the at least one elastic member is disposed in a lower surface of the protrusion, and
when the first block is coupled to the housing, the protrusion descends while maintaining a parallelism between the lower surface of the protrusion and the upper surface of the solid oxide cell stack.

20. The solid oxide reaction apparatus of claim 16, further comprising
at least one stack guide disposed in the housing and extending along a side surface of the solid oxide cell stack to limit a position of the solid oxide cell stack inside the housing and apply physical force by contacting edges of the solid oxide cell stack, and
a second block coupled to the housing at an opposite side of the first block,
wherein the second block comprises a second cover which covers a lower side of the housing and includes a recessed portion having a depth on an upper surface of the second cover to accommodate a lower portion of the solid oxide cell stack and an end portion of the at least one stack guide, and
the recessed portion has a shape corresponding to an outer shape of the solid oxide cell stack and the at least one stack guide, and an area of 10% to 30% larger than an area of a lower surface of the solid oxide cell stack.
